(19) United States
(12) Patent Application Publication
(10) Pub. No.: US 2013/0095002 A1
(43) Pub. Date: Apr. 18, 2013

(54) EXHAUST GAS PURIFYING FILTER, SYSTEM OF REGENERATING GASOLINE PARTICULATE FILTER, AND METHOD THEREOF

(71) Applicants: Chibum In, Yongin (KR); Jin Woo Choung, Suwon (KR)

(72) Inventors: Chibum In, Yongin (KR); Jin Woo Choung, Suwon (KR)

(73) Assignees: KIA MOTORS CORPORATION, Seoul (KR); HYUNDAI MOTOR COMPANY, Seoul (KR)

(21) Appl. No.: 13/534,823

(22) Filed: Jun. 27, 2012

(30) Foreign Application Priority Data
Oct. 13, 2011 (KR) 10-2011-0104662

(51) Int. Cl. B01D 50/00; B01J 20/34

(52) U.S. Cl. 422/169; 502/34

(57) ABSTRACT

An exhaust gas purifying filter, a system for regenerating a particulate filter, and a method therefore are disclosed. An exhaust gas purifying filter may include: an ammonia storage catalyst unit adapted to absorb ammonia contained in the exhaust gas when a temperature of the ammonia storage catalyst unit is lower than a predetermined temperature, release the absorbed ammonia when the temperature of the ammonia storage catalyst unit is higher than or equal to the predetermined temperature, and generate nitrogen oxide from the released ammonia; and a particulate filter adapted to trap particulate matter contained in the exhaust gas and regenerate the trapped particulate matter by using the nitrogen oxide generated from the ammonia storage catalyst unit.

### CROSS-REFERENCE TO RELATED APPLICATION

This application claims priority to and the benefit of Korean Patent Application No. 1 0-201 1-01 04662 filed in the Korean Intellectual Property Office on Oct. 13, 2011, the entire contents of which are incorporated herein by reference.

### BACKGROUND OF THE INVENTION

(a) Field of the Invention

The present invention relates to an exhaust gas purifying filter, a system for regenerating a particulate filter, and a method thereof. More particularly, the present invention relates to an exhaust gas purifying filter, and a system and a method for regenerating a particulate filter of a gasoline engine.

(b) Description of the Related Art

In general, a gasoline direct injection (GDI) technology involves direct injection of fuel into a combustion chamber as opposed to injection into an intake pipe. The technology has been developed so as to improve fuel consumption efficiency and performance of an internal combustion engine.

Since the air/fuel ratio is low (rich atmosphere) around a spark plug, an engine generally is operated in a lean fuel condition. However, this presents a problem in a gasoline direct injection engine (GDI) which generates a large amount of particulate matter (PM) during an incomplete combustion period increment in a combustion chamber. Accordingly, a particulate filter is mounted in a vehicle with a gasoline direct injection engine (GDI).

However, if such a vehicle operates at a low speed for a long time, it is difficult to passively regenerate particulate matter (PM) in the particulate filter because the temperature and oxygen concentration in the particulate filter are low.

In a conventional art, various devices for supplying oxygen to a particulate filter have been developed in an attempt to resolve such problems. In particular, regeneration of the particulate filter has been performed such that the particle matter (PM) trapped in the particulate filter is oxidized and eliminated by supplying additional air to the front end of the particulate filter mounted on an exhaust pipe.

Although the additional air is supplied to the front end of the particulate filter, a high temperature is required for oxidizing PM trapped in the particulate filter with oxygen. However, in the particulate filter of a gasoline engine, it is difficult to secure a temperature at which the particle matter (PM) and the oxygen can sufficiently react.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an exhaust gas purifying filter, and a system and a method for regenerating a particulate filter having advantages of sufficiently oxidizing particulate matter in a particulate filter of a gasoline engine.

In addition, the present invention has been made in an effort to provide an exhaust gas purifying filter, and a system and a method for regenerating a particulate filter having further advantages of oxidizing the particulate matter in the particulate filter of a gasoline engine at a lower temperature than typically required.

According to one aspect, the present invention provides an exhaust gas purifying filter that includes: an ammonia storage catalyst unit adapted to absorb ammonia contained in the exhaust gas when a temperature of the ammonia storage catalyst unit is lower than a predetermined temperature, release the absorbed ammonia when the temperature of the ammonia storage catalyst unit is higher than or equal to the predetermined temperature, and generate nitrogen oxide from the released ammonia; and a particulate filter adapted to trap particulate matter contained in the exhaust gas and regenerate the trapped particulate matter by using the nitrogen oxide generated by the ammonia storage catalyst unit.

According to various embodiments, the ammonia storage catalyst unit may further include a three-way catalyst layer.

According to various embodiments, the ammonia storage catalyst unit may include zeolite or an ammonia absorptive material.

According to another aspect of the present invention, a system is provided for regenerating a particulate filter, wherein the system may be mounted on an exhaust pipe of a gasoline engine. According to various embodiments, the system may include: a three-way catalyst device mounted on the exhaust pipe connected to the gasoline engine, the three-way catalyst device adapted to oxidize or reduce an exhaust gas exhausted from the gasoline engine; an ammonia storage catalyst unit mounted on the exhaust pipe downstream of the three-way catalyst device, wherein the ammonia storage catalyst unit is adapted to absorb ammonia generated in the three-way catalyst when a temperature of the ammonia storage catalyst unit is lower than a predetermined temperature, release the absorbed ammonia when the temperature of the ammonia storage catalyst unit is higher than or equal to the predetermined temperature, and generate nitrogen oxide from the released ammonia; a particulate filter mounted proximal to the ammonia storage catalyst unit, and adapted to trap particulate matter contained in the exhaust gas and regenerate the trapped particulate matter by using the nitrogen oxide generated from the ammonia storage catalyst unit; and a control portion adapted to control an air-fuel ratio of an air-fuel mixture flowing into the gasoline engine, wherein the control portion is further adapted to create a lean atmosphere when a pressure difference of the particulate filter is larger than or equal to a predetermined pressure difference. In particular, when used herein, creating a lean atmosphere refers to creating an atmosphere in which the air/fuel ratio is high (as opposed to a rich atmosphere in which the air/fuel ratio is low).

According to various embodiments, the control portion is adapted to create a rich atmosphere when a concentration of the ammonia is lower than or equal to a predetermined concentration.

According to various embodiments, the control portion is adapted to create a lean atmosphere depending on the temperature of the ammonia storage catalyst unit when the pressure difference of the particulate filter is larger than or equal to the predetermined pressure difference.

According to various embodiments, the ammonia storage catalyst unit further includes a three-way catalyst layer.

According to various embodiments, the ammonia storage catalyst unit includes zeolite or an ammonia absorptive material.

According to another aspect of the present invention, a system for regenerating a particulate filter is provided which can be applied to the present methods for regenerating a particulate filter. According to various embodiments, the method may include: absorbing the ammonia contained in the exhaust gas; comparing a pressure difference of the particulate filter to a predetermined pressure difference; creating a lean atmosphere when the pressure difference of the particulate filter is larger than or equal to the predetermined pressure difference; releasing the ammonia from the ammonia storage catalyst unit; generating nitrogen oxide from the released ammonia; and regenerating the particulate filter using the generated nitrogen oxide.

According to various embodiments, generating the nitrogen oxide is performed by creating a lean atmosphere depending on the temperature of the ammonia storage catalyst unit.

According to various embodiments, a ratio of the ammonia in the exhaust gas is raised by creating a rich atmosphere when the ammonia is absorbed.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

### BRIEF DESCRIPTION OF THE DRAWINGS

FIG. 1 and FIG. 2 are schematic diagrams of a system for purifying an exhaust gas according to an exemplary embodiment of the present invention.

FIG. 3 is a graph showing an absorption ratio of ammonia according to temperature change.

FIG. 4 is a flowchart of a method for purifying exhaust gas according to an exemplary embodiment of the present invention.

FIG. 5 is a graph showing a combustion ratio according to temperature change of particulate matter.

<Description of Symbols>

| | |
|---|---|
| 1: system for regenerating | |
| particulate filter | |
| 10: gasoline engine | |
| 11: cylinder | 13: injector |
| 15: intake manifold | 17: exhaust manifold |
| 19: exhaust pipe | |
| 20: three-way catalyst device | |
| 32: ammonia storage catalyst unit | |
| 33: ammonia storage layer | 34: three-way catalyst layer |
| 35: particulate filter | |
| 36: temperature sensor | 38: differential pressure sensor |
| 40: control portion | |

### DETAILED DESCRIPTION OF THE EMBODIMENTS

An exemplary embodiment of the present invention will hereinafter be described in detail with reference to the accompanying drawings.

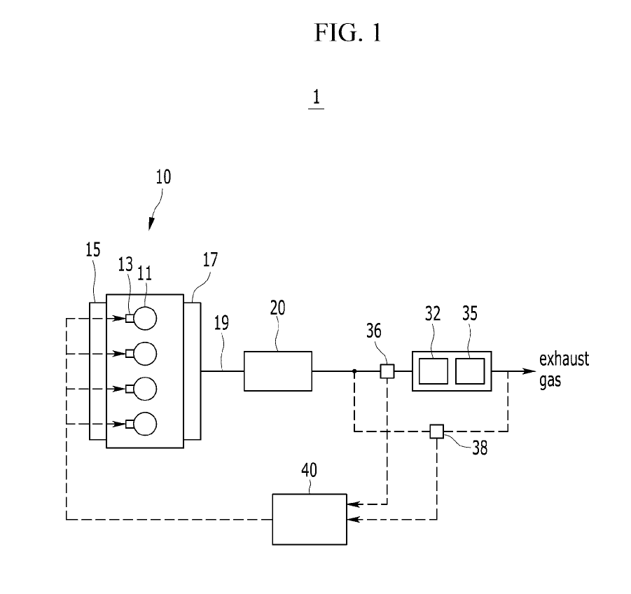

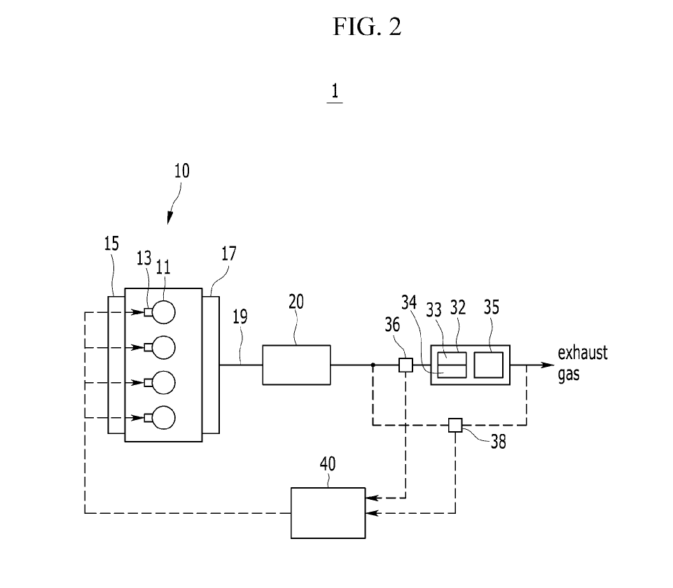

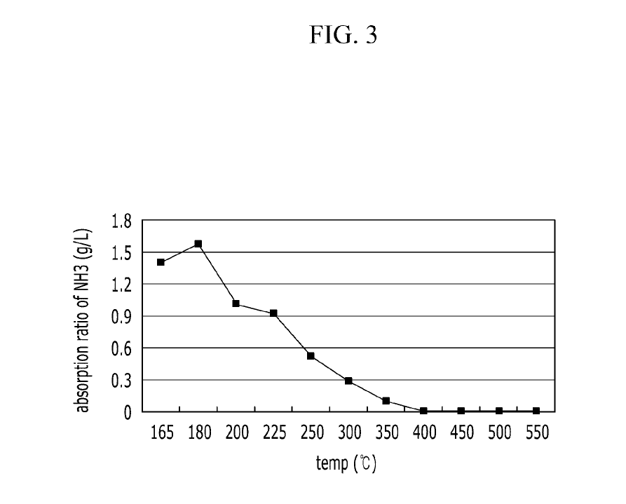

FIG. 1 and FIG. 2 are schematic diagrams of a system for purifying exhaust gas according to an exemplary embodiment of the present invention, and FIG. 3 is a graph showing an absorption ratio of ammonia according to temperature change.

Referring to FIG. 1 and FIG. 2, a system 1 for regenerating a particulate filter according to an exemplary embodiment of the present invention includes a gasoline engine 10, a three-way catalyst device 20, an ammonia storage catalyst unit 32, a particulate filter 35, and a control portion 40.

The gasoline engine 10 is an internal combustion engine using gasoline as a fuel, and burns fuel and air so as to convert chemical energy into mechanical energy. The gasoline engine 10 includes a plurality of cylinders 11 into which the fuel and the air flow, and an ignition device (not shown) for igniting the fuel and the air flowing into the cylinders 11. The gasoline engine 10 is connected to an intake manifold 15 so as to receive the air in the cylinders 11, and is connected to an exhaust manifold 17 such that exhaust gas generated in a combustion process is gathered in the exhaust manifold 17 and is exhausted to the exterior through an exhaust pipe 19. As further shown, an injector 13 can be mounted at the cylinders 11 so as to inject the fuel into the cylinders 11.

The three-way catalyst device 20 is mounted on the exhaust pipe 19, and is adapted to oxidize or reduce the exhaust gas exhausted from the gasoline engine 10. Generally, the three-way catalyst device 20 converts toxic chemicals (CO, HC, and NOₓ) in the exhaust gas into harmless gases (CO₂, H₂O, N₂, and O₂) by way of an oxidation-reduction reaction.

The three-way catalyst device 20 is a catalytic converter that stimulates the oxidation-reduction reaction, and generally includes a suitable catalyst, such as, for example, a combination of platinum (Pt), palladium (Pd), and rhodium (Rh). The platinum catalyst and the palladium catalyst stimulate the oxidation reaction to reduce carbon monoxide (CO) and hydrocarbon (HC), and the rhodium catalyst stimulates the reduction reaction to reduce nitrogen oxide (NO_{X}). If the air-fuel ratio is lean (i.e., air is rich as compared to fuel), the oxidation reaction for reducing carbon monoxide (CO) and hydrocarbon (HC) occurs actively in the three-way catalyst device 20 such that production ratios of water (H₂O) and carbon dioxide (CO₂) are increased. On the other and, if the air-fuel ratio is rich (i.e., air is lean as compared to fuel), the reduction reaction for reducing nitrogen oxide (NOₓ) actively occurs such that a production ratio of nitrogen N₂ is increased.

As shown in FIGS. 1 and 2, the ammonia storage catalyst unit 32 is mounted on the exhaust pipe 19 downstream of the three-way catalyst device 20. The ammonia storage catalyst unit 32 can, for example, be mounted in the proximity of the particulate filter 35, or can be mounted in the particulate filter 35. As shown in FIG. 1 and FIG. 2, the ammonia storage catalyst unit 32 and the particulate filter 35 can be provided in a common space.

The ammonia storage catalyst unit 32 is adapted to absorb and release ammonia (NH₃). As described above, if an excessive amount of fuel is supplied, ammonia (NH₃) is produced by reducing nitrogen oxide (NOₓ) in the three-way catalyst device 20. Therefore, the ammonia storage catalyst unit 32 is adapted to mainly absorb and release ammonia (NH₃) produced in the three-way catalyst device 20.

In the present system, an absorption ratio and a release ratio of ammonia (NH₃) in the ammonia storage catalyst unit 32 vary according to temperature. That is, the lower the temperature is, the higher the absorption ratio of ammonia (NH₃) in the ammonia storage catalyst unit 32. On the contrary, the higher the temperature is, the higher the release ratio of ammonia (NH₃) in the ammonia storage catalyst unit 32. Therefore, as shown in FIG. 3, ammonia (NH₃) produced in the three-way catalyst device 20 is mainly absorbed below a certain temperature of the ammonia storage catalyst unit 32 and is mainly released at a temperature higher than or equal to the certain temperature of the ammonia storage catalyst unit 32. According to an exemplary embodiment, the certain temperature may be, but is not limited to, about 350° C. Of course, this certain temperature can vary and can be, for example, about 300° C., about 310° C., about 320° C., about 330° C., about 340° C., about 360° C., about 370° C., about 380° C., etc.

The ammonia storage catalyst unit 32 can use various absorptive materials. According to an exemplary embodiment, one of the absorptive materials may be zeolite.

As shown in FIG. 2, the ammonia storage catalyst unit 32 can include, in addition to the ammonia storage layer 33, a three-way catalyst layer 34. According to an embodiment, one of the ammonia storage layer 33 or the three-way catalyst layer 34 is provided on the other (i.e. the three-way catalyst layer 34 or the ammonia storage layer 33 respectively) in the ammonia storage catalyst unit 32. In particular, according to one embodiment the three-way catalyst layer 34 is disposed on the ammonia storage layer 33, but such disposition of the three-way catalyst layer 34 and the ammonia storage layer 33 are not limited as such.

As shown in FIGS. 1 and 2, the three-way catalyst layer 34 and the three-way catalyst device 20 are provided separated from each other. According to preferred embodiments, the three-way catalyst layer 34, like the three-way catalyst device 20, is adapted to oxidize or reduce exhaust gas. Thus, for example, if the fuel is supplied excessively (i.e., air-fuel ratio is rich), the three-way catalyst layer 34 produces ammonia (NH₃) by reducing nitrogen oxide (NOₓ) which is not reduced in the three-way catalyst device 20. Therefore, an ammonia (NH₃) ratio in the exhaust gas passing to the ammonia storage layer 33 is increased. Also, if oxygen (O₂) is supplied excessively (i.e., air-fuel ratio is lean), then the three-way catalyst layer 34 increases the production ratio of nitrogen oxide (NOₓ), particularly nitrogen dioxide (NO₂), particularly by stimulating the oxidation reaction of ammonia (NH₃) released from the ammonia storage layer 33.

As shown in FIGS. 1 and 2, the particulate filter 35 is mounted downstream in the proximity of the ammonia storage catalyst unit 32, and is adapted to trap particulate matter (PM) in the exhaust gas. The particulate matter (PM) mainly comprises hydrocarbon that is called soot, a soluble organic fraction, and so on. The particulate filter 35 is adapted to trap the particulate matter (PM). According to a preferred embodiment, the particulate filter 35 has a honeycomb structure.

However, if the particulate matter (PM) becomes trapped in the particulate filter 35, the flow of the exhaust gas may be interrupted. Therefore, the particulate filter 35 is configured to perform a regeneration process to oxidize and eliminate the particulate matter (PM). In particular, if particulate matter (PM) of more than a certain amount is trapped in the particulate filter 35, then a pressure difference is created in the particulate filter 35. A pressure sensor 38 is configured and arranged to measure this pressure difference. If the pressure difference measured by the differential pressure sensor 38 is higher than or equal to a predetermined pressure difference, then the particulate filter 35 performs a regeneration process.

The particulate filter 35 is adapted to regenerate the particulate matter (PM) using the nitrogen oxide (NOₓ), particularly nitrogen dioxide (NO₂), which is generated by oxidizing the ammonia (NH₃) released from the ammonia storage catalyst unit 32. That is, the particulate matter (PM) is oxidized and eliminated by an oxidation reaction with the nitrogen oxide (NOₓ), particularly nitrogen dioxide (NO₂).

As shown in FIGS. 1 and 2, a control portion 40 is provided which is adapted to control an air-fuel ratio of an air-fuel mixture flowing into the gasoline engine 10. In particular, the control portion 40 is adapted to control the fuel amount and the air amount flowing into the gasoline engine 10 so as to control the oxygen (O₂) ratio in the exhaust gas.

The control portion 40 receives the pressure difference value measured by the differential pressure sensor 38, compares the measured pressure difference value with a predetermined pressure difference value, and determines whether the particulate filter 35 will be regenerated. If the pressure difference of the particulate filter 35 is larger than or equal to the predetermined pressure difference, then the control portion 40 is adapted to create a lean atmosphere. In particular, the control portion 40 is adapted to increase the oxygen (O₂) ratio in the exhaust gas so as to oxidize and eliminate the particulate matter (PM), mainly carbon (C) particles, from the particulate filter 35. According to an exemplary embodiment, the control portion 40 is adapted to control the injector 13 and can, for example, stop the supply of fuel into the cylinder 11 so as to increase the oxygen (O₂) ratio in the exhaust gas.

Further, the present system is configured such that when controlling the air-fuel ratio to be lean for regeneration of the particulate filter 35, the control portion 40 is adapted to further control the air-fuel ratio depending to the temperature of the ammonia storage catalyst unit 32 as measured by a temperature sensor 36. In particular, after determining whether the particulate filter 35 will be regenerated, the control portion 40 is adapted to control the air-fuel ratio by comparing the temperature measured in the temperature sensor 36 with a releasable temperature (e.g., about 350° C.) in the ammonia storage catalyst unit 32. This releasable temperature is a temperature at which the ammonia (NH₃) can be released in the ammonia storage catalyst unit 32. For example, if the temperature measured in the temperature sensor 36 is lower than the releasable temperature in the ammonia storage catalyst unit 32, then the control portion 40 is adapted to increase the oxygen (O₂) ratio in the exhaust gas so as to increase the measured temperature to the releasable temperature of the ammonia storage catalyst unit 32.

The control portion 40 is further adapted to control the ammonia (NH₃) ratio in the exhaust gas. For example, the control portion 40 can receive the ammonia (NH₃) concentration value as measured by an ammonia concentration measure sensor (not shown), and compare the measured ammonia (NH₃) concentration with a predetermined concentration. If the measured ammonia (NH₃) concentration is lower than the predetermined concentration, then the control portion 40 can be adapted to create a rich atmosphere. In particular, the control portion 40 is adapted to control the injector 13 and supply the fuel in an excessive amount to the cylinder 11 so as to increase the ammonia (NH₃) ratio in the exhaust gas.

The control portion 40 can further be configured to calculate the ammonia (NH₃) ratio in the exhaust gas depending on parameters (e.g., an engine operation condition, an exhaust gas temperature, an air-fuel ratio, a degradation amount of the catalyst, and so an), and the control portion 40 can include a map table in which the ammonia (NH₃) ratio according to the parameters is stored in advance.

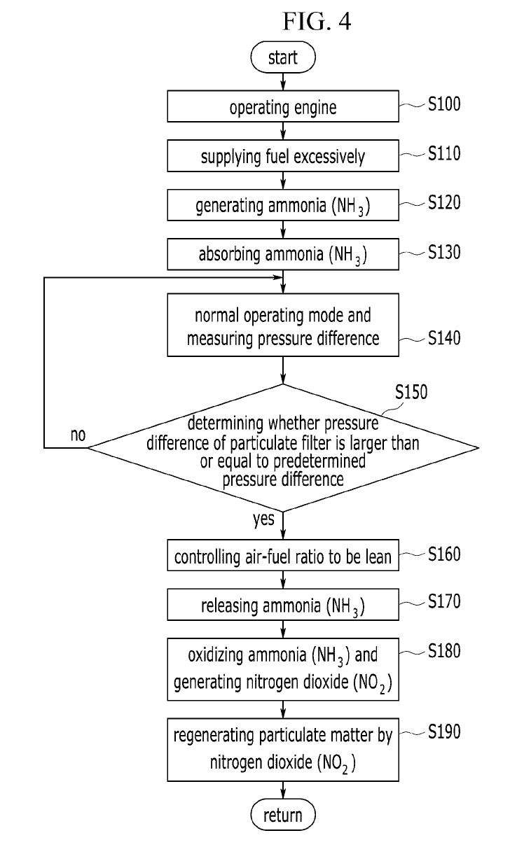

FIG. 4 is a flowchart showing a method for purifying exhaust gas according to an exemplary embodiment of the present invention.

Referring to FIG. 4, a regenerating method using the system 1 as shown in FIGS. 1 and 2 will be described in detail.

Referring to FIG. 4, the system 1 for regenerating the particulate filter is operated while the engine operates beginning at step S100. If the gasoline engine 10 is operated and the fuel is supplied excessively into the gasoline engine 10 (step S110) (i.e. if the air-fuel ratio is rich), then the reduction reaction of the nitrogen oxide (NOx) is stimulated in the three-way catalyst device 20 and the ammonia (NH₃) is produced at step S120. Typically, in an initial operation region and at a high load region, the fuel is supplied excessively for protecting the exhaust manifold 17 and the catalyst of the three-way catalyst device 20. Also, if the ammonia (NH₃) concentration as measured by the ammonia concentration measure sensor (not shown) or as calculated by the control portion 40 is lower than the predetermined concentration, then the control portion 40 is adapted to control the injector 13 so as to supply the fuel excessively. The ammonia NH₃ of the exhaust gas exhausted in the three-way catalyst device 20 is then absorbed in the ammonia storage catalyst unit 32 at step S130. As described above, the ammonia (NH3) is absorbed below the certain temperature, (e.g., about 350° C.) in the ammonia storage catalyst unit 32. Because the temperature of the exhaust gas is not higher than the releasable temperature during a normal operating mode of the gasoline engine 10, a majority of the ammonia (NH₃) is absorbed in the ammonia storage catalyst unit 32.

The differential pressure sensor 38 measures the pressure difference of the particulate filter 35 during the normal operating mode of the gasoline engine 10 at step S140, and transmits the measured pressure difference to the control portion 40.

Then, the control portion 40 determines whether the pressure difference of the particulate filter 35 is larger than or equal to the predetermined pressure difference at step S150. If the pressure difference of the particulate filter 35 is larger than or equal to the predetermined pressure difference, the control portion 40 is adapted to control the air-fuel ratio in the gasoline engine 10 to be lean at step S160. Since the oxygen (O₂) ratio in the exhaust gas exhausted from the gasoline engine 10 is increased, the oxidation reaction in the three-way catalyst device 20 is stimulated, thereby increasing the temperature of the exhaust gas by the generated oxidation heat. Therefore, if the increased temperature of the exhaust gas is higher than or equal to the certain temperature (e.g., about 350° C.), then ammonia (NH₃) is released from the ammonia storage layer 33 of the ammonia storage catalyst unit 32 at step S170. Next, the released ammonia (NH₃) is oxidized such that the nitrogen oxide (NOₓ), particularly nitrogen dioxide (NO₂), is generated at step S180. Then the particulate matter (PM) in the particulate filter 35 is oxidized and eliminated by the nitrogen oxide (NOx), particularly nitrogen dioxide (NO₂), at step S190. That is, the particulate filter 35 is regenerated.

Generally, the particulate filter 35 is adapted to oxidize and eliminate the particulate matter (PM) using oxygen (O₂) gas, but the system 1 for regenerating the particulate filter may also be adapted to oxidize and eliminate the particulate matter (PM) using nitrogen dioxide (NO₂).

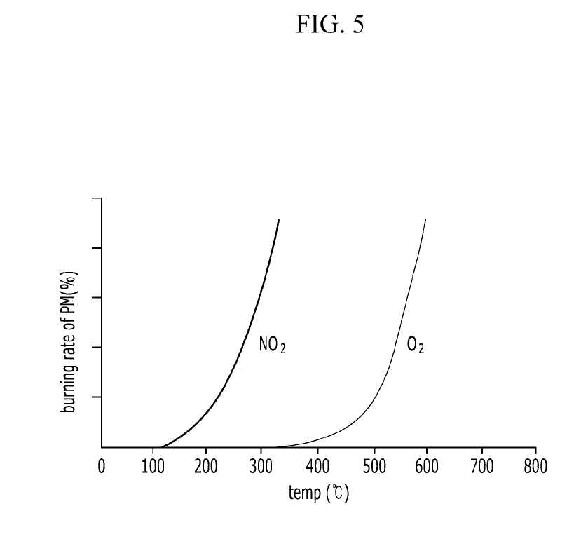

FIG. 5 is a graph for showing a combustion ratio according to temperature change of particulate matter.

Referring to FIG. 5, an ambient temperature must be higher than or equal to about 400° C. at a minimum for oxidizing (i.e., burning) the particulate matter (PM) (e.g. soot) trapped in the particulate filter with oxygen (O₂) gas. However, as shown, nitrogen dioxide (NO₂) can oxidize (i.e., burn) the particulate matter (PM) below 400° C.

Therefore, the system 1 for regenerating the particulate filter is adapted to increase nitrogen dioxide (NO₂) flowing into the particulate filter 35 such that the particulate matter (PM) is oxidized and eliminated by the nitrogen dioxide (NO₂) at a lower temperature when the particulate filter 35 is to be regenerated.

As described above, the particulate matter (PM) in the particulate filter 35 of the gasoline engine may be sufficiently oxidized according to exemplary embodiments of the present invention

Also, the particulate matter (PM) in the particulate filter 35 of the gasoline engine may be oxidized at a temperature lower than typically required.

While this invention has been described in connection with what is presently considered to be practical exemplary embodiments, it is to be understood that the invention is not limited to the disclosed embodiments. On the contrary, it is intended to cover various modifications and equivalent arrangements included within the spirit and scope of the appended claims.

What is claimed is:

1. An exhaust gas purifying filter, comprising:
an ammonia storage catalyst unit adapted to (a) absorb ammonia contained in the exhaust gas when a temperature of the ammonia storage catalyst unit is lower than a predetermined temperature, (b) release the absorbed ammonia when the temperature of the ammonia storage catalyst unit is higher than or equal to the predetermined temperature, and (c) generate nitrogen oxide from the released ammonia; and
a particulate filter adapted to trap particulate matter contained in the exhaust gas and regenerate the trapped particulate matter by using the nitrogen oxide generated from the ammonia storage catalyst unit.

2. The filter of claim 1, wherein the ammonia storage catalyst unit further comprises a three-way catalyst layer.

3. The filter of claim 1, wherein the ammonia storage catalyst unit comprises zeolite or an ammonia absorptive material.

4. A system for regenerating a particulate filter that is mounted on an exhaust pipe of a gasoline engine, the system comprising:
a three-way catalyst device disposed on the exhaust pipe, and adapted to oxidize or reduce exhaust gas exhausted from the gasoline engine;
an ammonia storage catalyst unit mounted on the exhaust pipe downstream of the three-way catalyst device, and adapted to (a) absorb ammonia generated in the three-way catalyst device when a temperature of the ammonia storage catalyst unit is lower than a predetermined temperature, (b) release the absorbed ammonia when the temperature of the ammonia storage catalyst unit is higher than or equal to the predetermined temperature, and (c) generate nitrogen oxide from the released ammonia;
a particulate filter disposed near the ammonia storage catalyst unit, and adapted to trap particulate matter contained in the exhaust gas and to regenerate the trapped particulate matter by using the nitrogen oxide generated from the ammonia storage catalyst unit; and
a control portion adapted to control an air-fuel ratio of an air-fuel mixture flowing into the gasoline engine,
wherein the control portion is adapted to create a lean atmosphere when a pressure difference of the particulate filter is larger than or equal to a predetermined pressure difference.

5. The system of claim 4, wherein the control portion is adapted to create a rich atmosphere when a concentration of the ammonia is lower than or equal to a predetermined concentration.

6. The system of claim 4, wherein the control portion is adapted to create a lean atmosphere depending on the temperature of the ammonia storage catalyst unit when the pressure difference of the particulate filter is larger than or equal to the predetermined pressure difference.

7. The system of claim 4, wherein the ammonia storage catalyst unit further comprises a three-way catalyst layer.

8. The system of claim 4, wherein the ammonia storage catalyst unit comprises zeolite or an ammonia absorptive material.

9. A method for regenerating a particulate filter that comprises an ammonia storage catalyst unit adapted to absorb or release ammonia contained in exhaust gas depending on a temperature of the ammonia storage catalyst unit, and a particulate filter adapted to trap particulate matter contained in the exhaust gas, the method comprising:
absorbing ammonia contained in the exhaust gas;
comparing a pressure difference of the particulate filter to a predetermined pressure difference;
creating a lean atmosphere when the pressure difference of the particulate filter is larger than or equal to the predetermined pressure difference;
releasing the ammonia from the ammonia storage catalyst unit;
generating nitrogen oxide from the released ammonia; and
regenerating the particulate filter using the generated nitrogen oxide.

10. The method of claim 9, wherein the step of generating the nitrogen oxide is performed by creating a lean atmosphere depending on the temperature of the ammonia storage catalyst unit.

11. The method of claim 9, wherein a ratio of the ammonia in the exhaust gas is raised by creating a rich atmosphere when the ammonia is absorbed.
